(19) United States
(12) Patent Application Publication
(10) Pub. No.: US 2024/0429540 A1
(43) Pub. Date: Dec. 26, 2024

(54) BATTERY POSITIONING ELEMENT

(71) Applicant: Taicang Manaflex Technology Co., Ltd., Taicang City (CN)

(72) Inventors: Robert C. LANE, Las Vegas, NV (US); Yifei LIU, Toronto (CA); Augusto E. BARTON, Pinecrest, FL (US)

(21) Appl. No.: 18/749,509

(22) Filed: Jun. 20, 2024

(30) Foreign Application Priority Data
Jun. 21, 2023 (CN) 202321601233.8

(51) Int. Cl. H01M 50/289; H01M 50/213; H01M 50/244; H01M 50/505

(52) U.S. Cl. CPC H01M 50/289; H01M 50/213; H01M 50/244; H01M 50/505

(57) ABSTRACT

A battery positioning element and a battery pack to which it is applied. The battery positioning element is fixed in a group to a busbar plate of the battery pack, and a region for battery positioning is formed along the outer side of the pole lugs of the busbar plate. The battery positioning element includes a base plate and a clamping portion connected to the base plate, and the clamping portion has a clamping groove corresponding to the batteries formed on the outer side of the clamping portion. The battery positioning element locates and fixes the battery to the busbar plate of the battery pack, which is convenient for welding, and in addition, avoids shaking between the batteries during the use of the battery pack, and prolongs the service life of the battery pack.

### CROSS-REFERENCE TO RELATED APPLICATION

This application claims priority under 35 U.S.C. § 119 to Chinese Utility Model Application No. 202321601233.8 filed on Jun. 21, 2023, the disclosure of which is hereby incorporated by reference in its entirety for all purposes.

### TECHNICAL FIELD

The present invention relates to the technical field of new energy vehicles, and in particular to a battery positioning element.

### BACKGROUND

At present, the lithium-ion starting battery for vehicles, such batteries require a large starting current, is generally between 200 A˜2000 A. The starting battery in the existing market is composed of a small capacity cell (battery). Small capacity cell manufacturing process is mature, high safety performance, low processing cost. Such cells can also satisfy the vehicle startup by multi-parallel, and the traditional way of combing is to tie the cell group with a band, then put it into the shell, and fix it with a few fixed blocks or fireproof foam filling. However, the heat dissipation effect of the cell is poor, the cell positioning accuracy is poor, the adjacent cell short circuit risk is high, and for industrial production efficiency is low. Therefore, it is necessary to propose improvements.

### SUMMARY

The present invention aims to provide a battery positioning element to overcome the shortcomings in the prior technology.

In order to realize the above purposes, the present invention provides the following technical schemes:

In one embodiment, the present invention discloses a battery positioning element, which is fixed on the busbar plate of the battery pack, and forms an area for battery positioning along the pole lug of the busbar plate, including a bottom plate and three clamping parts connected to the bottom plate, the bottom plate is fixed on the busbar plate of the battery pack, the three clamping parts are equidistant circular array settings, and the outer side of each gripper part is formed with a gripper groove corresponding to the battery.

Further, in the battery positioning element, the two sides of the clamping slot are respectively convex and extended with a contact part, and the outer side of the contact part is a cambered structure.

Further, in the battery positioning element, one end of the contact part deviating from the busbar plate is provided with a guide surface.

Further, in the battery positioning element, the bottom plate is glued to the busbar plate.

Further, in the battery positioning element, the bottom of the bottom plate is protruded with a splice column, and the busbar plate is provided with a splice hole corresponding to the splice column.

Further, in the battery positioning element, the surface of the splice column is protruded with a splice edge, and the splice edge matches with the splice hole.

Further, in the battery positioning element, one end of the splice column is arranged away from the bottom plate, and the center of the splice column is arranged with an opening slot extending to the splice column.

Further, in the battery positioning element, the splice column is made of hot melt material, and the end of the splice column deviating from the base plate is thermally bonded to the corresponding surface of the busbar after passing through the splice hole.

Further, in the battery positioning element, every three to six of the battery positioning elements are used in combination.

The embodiment of the present invention also discloses a battery positioning element, including the battery positioning element.

Compared with the prior technology, the present invention has the advantages that the battery positioning element has simple structure, the battery positioning is fixed on the busbar plate of the battery pack, and is convenient for welding. In addition, the shaking between the batteries during the use of the battery pack is avoided, the safety of use is improved and the service life of the battery pack is extended.

### BRIEF DESCRIPTION OF THE DRAWINGS

In order to more clearly explain the technical scheme of the present invention embodiments, the following will be a simple introduction to the embodiments. It is obvious that the drawings described below are only some embodiments recorded in the present invention. For ordinary technical personnel in the field, under the premise of not paying creative labor. Other drawings can also be obtained according to these drawings.

FIG. 1 shows a structural diagram of a battery positioning element in a specific embodiment of the present invention.

FIG. 2 shows the adhesive connection diagram between the battery positioning element and the busbar plate in a specific embodiment of the present invention.

FIG. 3 shows the connection diagram of a splice column and a splice hole in a specific embodiment of the present invention.

FIG. 4 shows the connection diagram of a plunger post and a plunger hole in another specific embodiment of the present invention.

FIG. 5 shows the connection diagram of a plunger post and a plunger hole in another specific embodiment of the present invention.

FIG. 6 is a schematic diagram of the position of the battery positioning element and the battery in a specific embodiment of the present invention.

FIG. 7 shows the installation schematic diagram of the battery positioning element and battery in a specific embodiment of the present invention.

FIG. 8 shows the installation schematic diagram of the battery positioning element and battery in another specific embodiment of the present invention.

FIG. 9 shows the installation schematic diagram of the battery, the battery positioning element and the busbar plate after part of the battery is omitted in a specific embodiment of the present invention.

FIG. 10 shows a bottom perspective view of an embodiment of a busbar plate according to the present invention.

FIG. 11 shows a top perspective view of the busbar plate illustrated in FIG. 10.

FIG. 12 shows a bottom perspective view of another embodiment of a battery positioning element according to the present invention.

FIG. 13 shows a bottom view of the battery positioning element illustrated in FIG. 12.

### DETAILED DESCRIPTION OF THE INVENTION

The following is a detailed description of the technical scheme of the present invention embodiment in combination with the drawings attached to the embodiment of the present invention. Obviously, the described embodiment is only a part of the embodiment of the present invention not all of the possible embodiment(s). Based on the embodiment of the present invention, all other embodiments obtained by ordinary technical personnel in the field under the premise of not making creative labor belong to the scope of protection of the present invention.

In the description of the present invention, it needs to be explained that the orientation or position relationship indicated by the terms “center,” “up,” “down,” “left,” “right,” “vertical,” “horizontal,” “inside,” “outside,” etc. is based on the orientation or position relationship shown in the attached drawings, and are only for the purpose of facilitating the description of the present invention and simplifying the description, rather than indicating or implying that the device or element must have a specific orientation, structure and operation in a specific orientation, so it cannot be understood as a limitation of the present invention. In addition, the terms “first,” “second,” and “third” are used only for descriptive purposes and cannot be understood as indicating or suggesting relative importance.

In the description of the present invention, it needs to be noted that, unless otherwise expressly specified and limited, the terms “installation,” “connecting” and “connection” shall be broadly understood, for example, can be fixed connection, can also be detachable connection, or one connection; it can be a mechanical connection or an electrical connection; it can be directly connected, or indirectly connected through an intermediate medium, and it can be the connection within the two components. For ordinary technical personnel in the field, the specific meaning of the above terms in the present invention can be understood in specific circumstances.

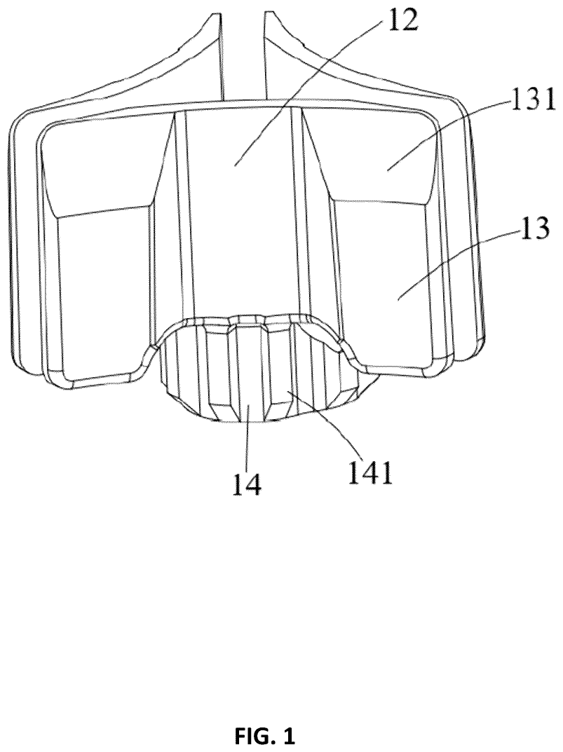

Referring to FIG. 1 to FIGS. 9, a battery positioning element 1 is used in a plurality of combinations and fixed on the busbar plate 2 of the battery pack, and an area for battery positioning is formed along the outer side of the pole lug 3 of the busbar plate 2, comprising a bottom plate 11 and three equally spaced circular arrays arranged and connected to the gripper part 12 of the bottom plate 11, and the bottom plate 11 is fixed on the busbar plate 2 of the battery pack. The outer side of the clamping part 12 is formed with a clamping slot corresponding to the battery 4.

In the technical scheme, the busbar plate 2 and the pole lug 3 are based on conventional technology, so they will not be described here one by one. In one embodiment, the whole battery positioning element can be formed by 3D printing or injection molding and/or other processes. The battery positioning element is fixed on the busbar plate, and the clamping groove of a plurality of clamping parts is enclosed into an area for battery positioning, and the pole lug is exposed. Avoid interfering with the welding between the battery and the busbar plate, through the setting of the battery positioning element, the battery can be quickly and accurately positioned, and radially fixed, easy to weld, the adjacent battery between the complete interval and fixed, to avoid shaking and other adverse consequences such as contact short circuit caused by the battery positioning element will be connected to the battery surface and the busbar plate, the battery generated heat transfer to the busbar plate, and improve the heat dissipation effect.

By example, as shown in FIG. 1, the two sides of the clamping groove are respectively convex and extended with a contact part 13, and the outer side of the contact part 13 is a cambered structure.

In the technical scheme, the overall clamping part has an arc structure, and its internal concave surface is directly used as a clamping groove, and both sides of the clamping groove are protruded to one side of the internal concave side. When in use, after the overall clamping part has a certain deformation, the contacting part is held on the battery surface, thus exerting a force pointing to the center of the battery. The clamping part between the contacting part is thin and easy to deform. It also ensures the smooth installation of the battery.

Illustratively, as shown in FIG. 1, a guide surface 131 is provided at the end of the contact part 13 deviating from the busbar-plate 2.

In the technical scheme, the guide surface is arranged so that the battery can be inserted into the clamping slot to form an area for battery positioning. The bottom of the battery is in contact with the guide surface before the guide surface, and during the continued installation of the battery, the guide surface is squeezed to force the clamping part to deform, so that a force pointing to its center is applied to the battery after installation to position and fix the battery.

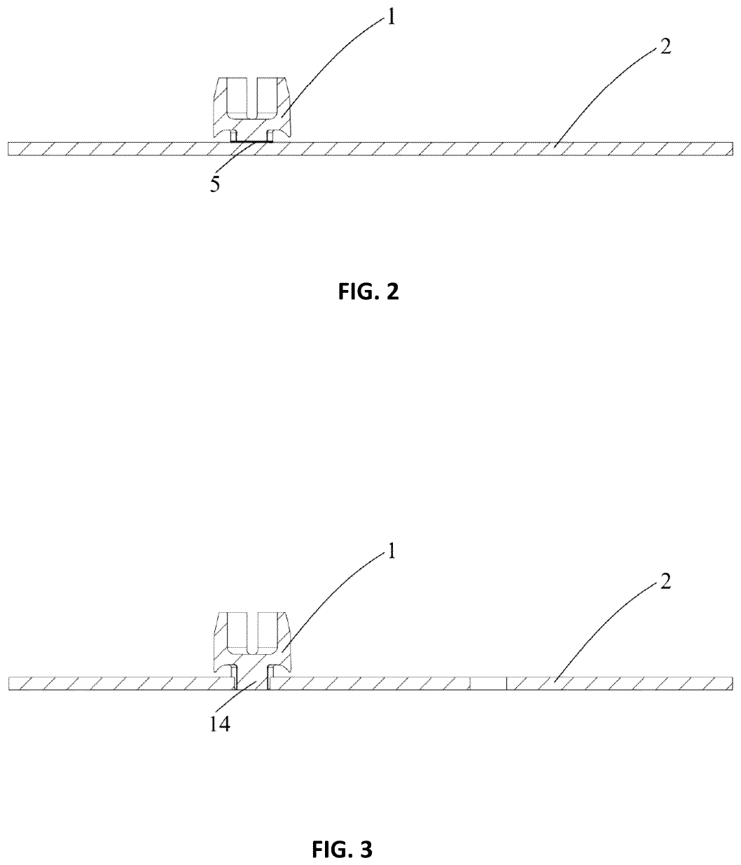

Illustratively, as shown in FIG. 2, the bottom plate 11 is glued to the busbar plate 2.

In the technical scheme, the base plate is fixed to the corresponding position of the busbar plate through high-temperature glue 5, etc., to achieve the fixing of the battery positioning element.

For example, as shown in FIG. 3 to FIG. 5, the bottom of the base plate 11 is protruded with a splice post 14, and the busbar 2 is provided with a splice hole 21 corresponding to the splice post.

In the technical scheme, the base plate is fixed at the corresponding position of the busbar plate by inserting and inserting the inserting column in the inserting hole, so as to realize the fixing of the positioning element of the battery. The inserting hole can be a through hole or a blind hole, and its cross-section is round, square or long oval shape. The inserting column and the inserting hole can be set accordingly.

For example, as shown in FIG. 3, the surface of the splice column 14 is protruded with a number of splice edges 141 set at intervals, and the splice edges 141 fit with the splice holes 21.

In the technical scheme, during the process of inserting the plunger into the plunger hole, the plunger edge is extruded from the inner wall of the plunger hole, and the plunger edge is deformed and embedded between the plunger hole and the plunger column, and the bottom plate is fixed at the corresponding position of the busbar to realize the fixing of the battery positioning element.

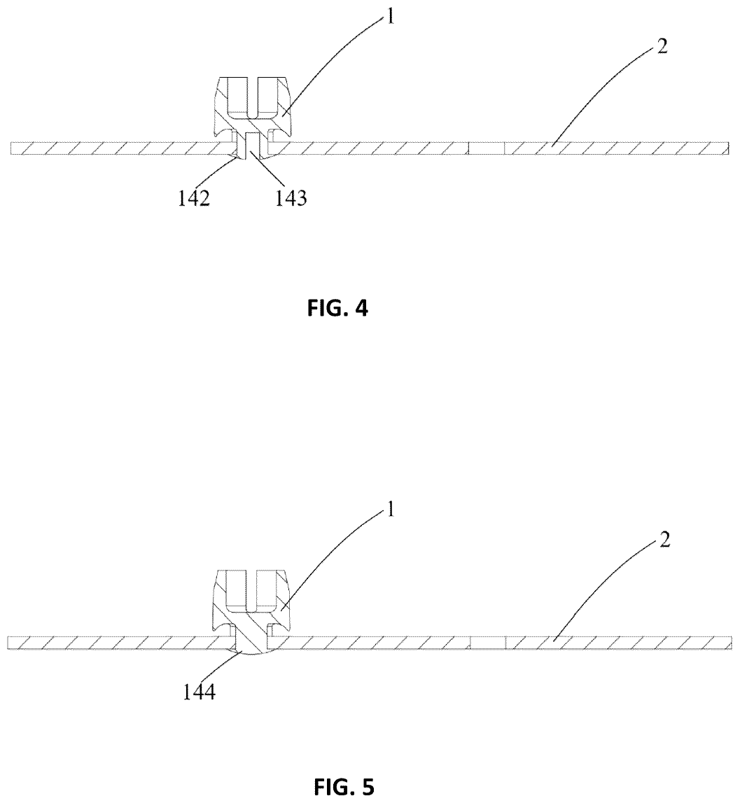

For example, as shown in FIG. 4, the end of the splice post 14 away from the bottom plate 11 is provided with a splice connector 142, and the center of the splice post is provided with an opening slot 143 extending to the splice post 14.

In this technical solution, the shape of the splice part is not unique, and the existing splice structure can be directly used. During the process of inserting the splice post into the splice hole, the splice part squeezes the splice post into the open slot, and the splice part is reset after passing through the busbar plate, and is stuck to the back of the busbar plate (away from the battery side).

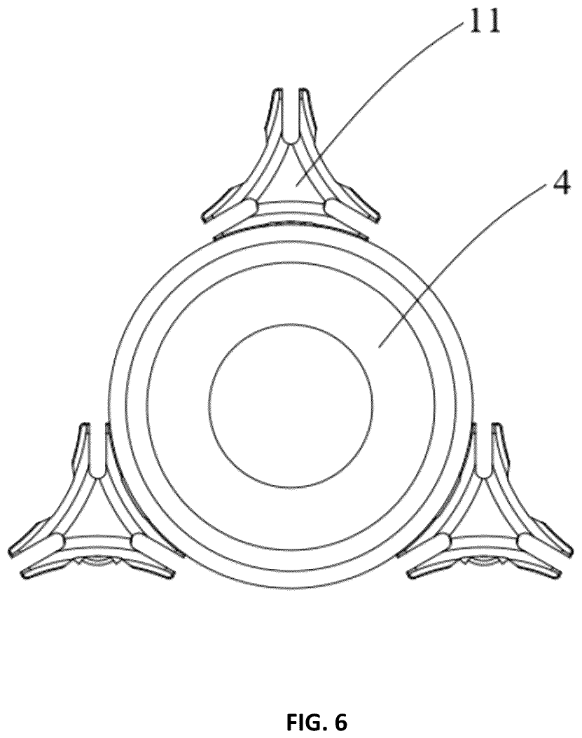

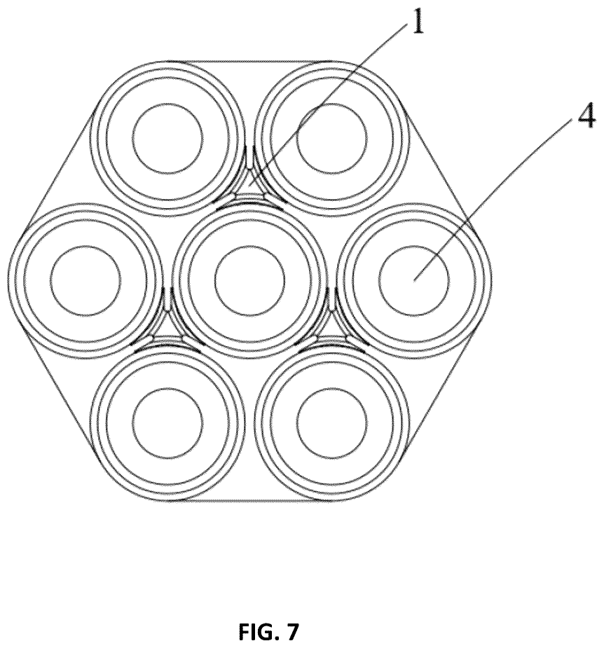

For example, see FIG. 5, wherein the socket post 14 is made of hot melt material, and the end of the socket post 11 runs through the socket hole 21 and is thermally bonded to the corresponding surface of the busbar 2.

In the technical scheme, the plug column is made of hot melt material, its length is greater than the depth of the plug hole, the plug column is inserted into the plug hole, protruding from the plug hole, and the protruding end is hot pressed on the corresponding surface of the busbar plate by electric soldering iron, or melted and then condensed into the anti-stripping part 144 larger than its diameter.

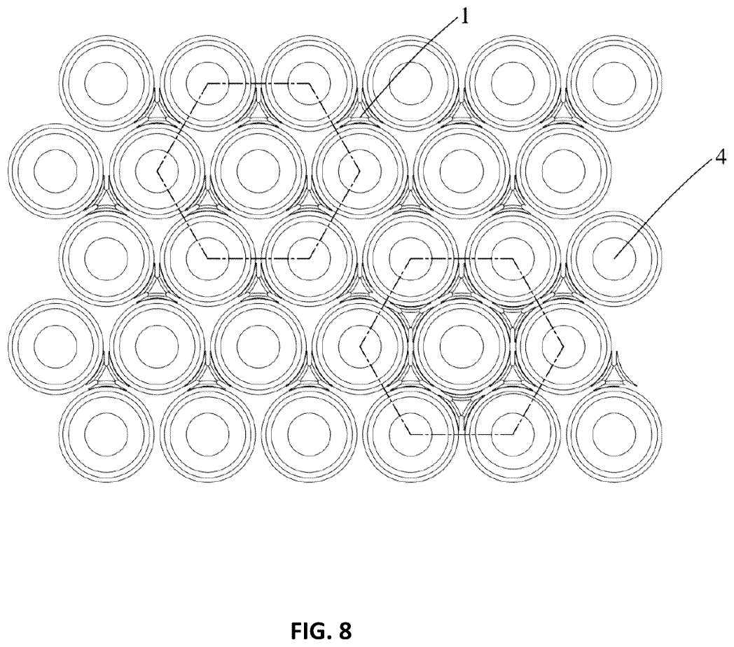

Illustratively, see FIG. 6 and FIG. 8 for a combination of every three to six battery positioning elements 1.

In this technical scheme, each battery positioning element is in contact with three cells simultaneously.

For example, as shown in FIG. 6, a battery requires at least three cell positioning elements to apply radials simultaneously to ensure a balanced force on the battery.

For example, as shown in FIG. 7, the battery pack periphery also needs to be equipped with insulation packaging materials to combine all batteries as a whole and isolate external water vapor, etc. The peripheral battery is jointly fixed by the battery positioning element and the insulation packaging material, and only one battery positioning element is required.

For example, as shown in FIG. 8, the battery in the inner ring of the battery pack (which has no contact with the insulation packaging material, etc.) and its adjacent batteries are fixed to each other through three to six (in the center line of the hexagon, the hexagon does not exist physically, but is only used to illustrate the range of adjacent batteries).

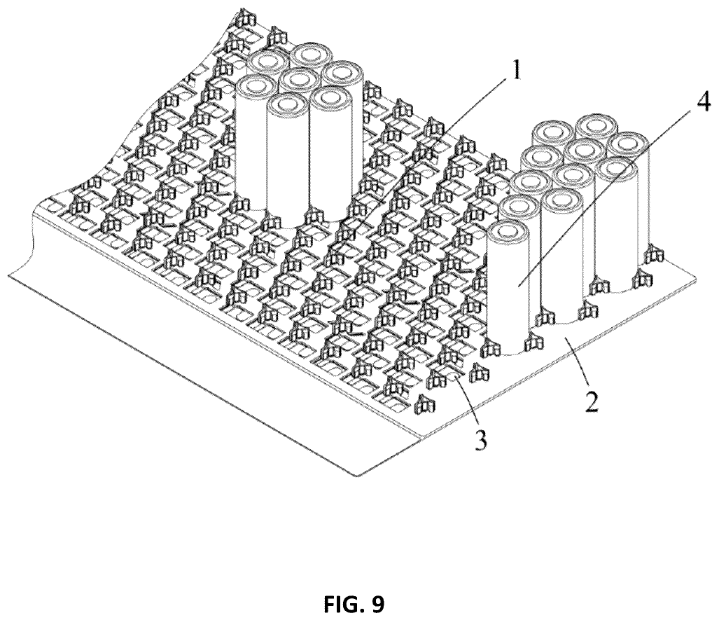

Illustratively, as shown in FIG. 9, a battery pack comprises several of the cell positioning elements 1.

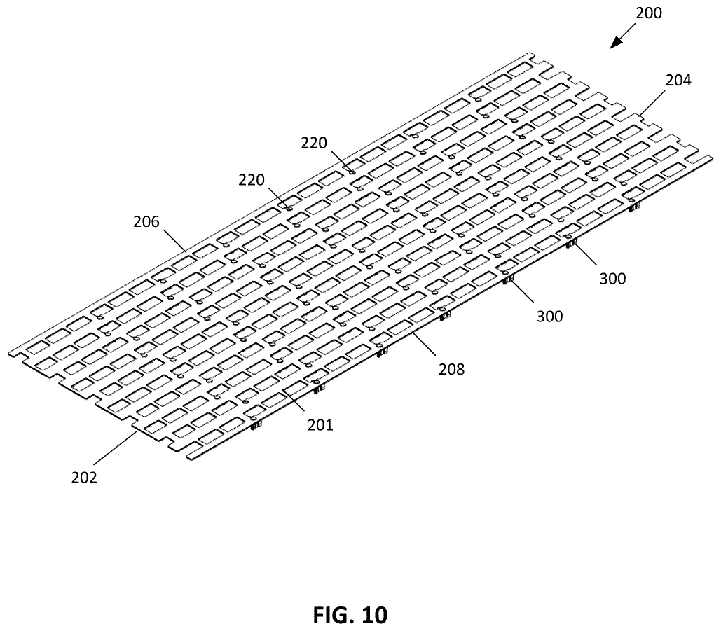

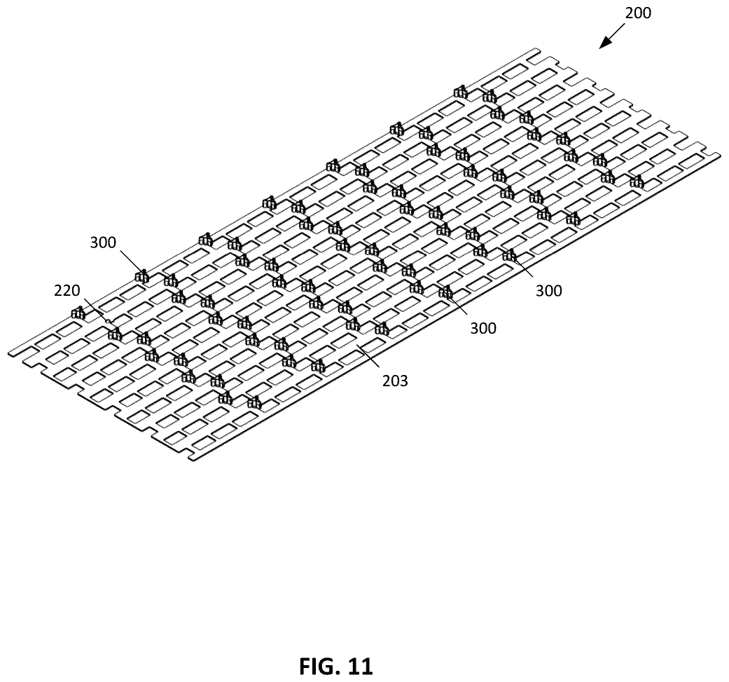

Referring to FIGS. 10 and 11, bottom and top perspective views of an embodiment of a busbar plate are illustrated. Busbar plate 200 has opposite ends 202 and 204 and opposite sides 206 and 208. The busbar plate 200 has a lower surface 201 and an upper surface 203, and has mounting holes 220 extending therethrough. Coupled to the busbar plate 200 are several battery positioning elements 300, which extend from the upper surface 203. In this embodiment, as described in greater detail below, each battery positioning element 300 interfaces with busbar plate 200 and has an elongated oval-like shape that goes into slots or openings 220 formed in the busbar plate 200. The battery positioning elements 300 controls and constrains the orientation of the battery cells.

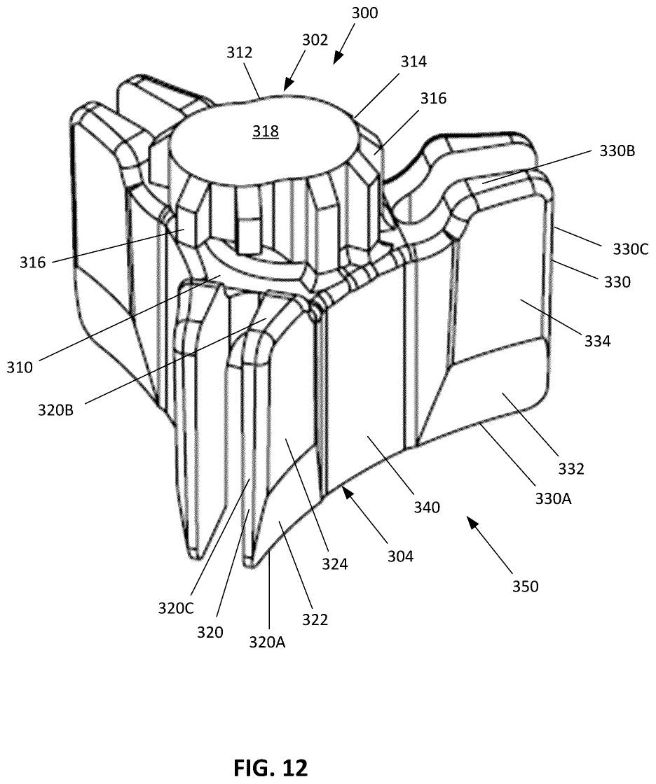

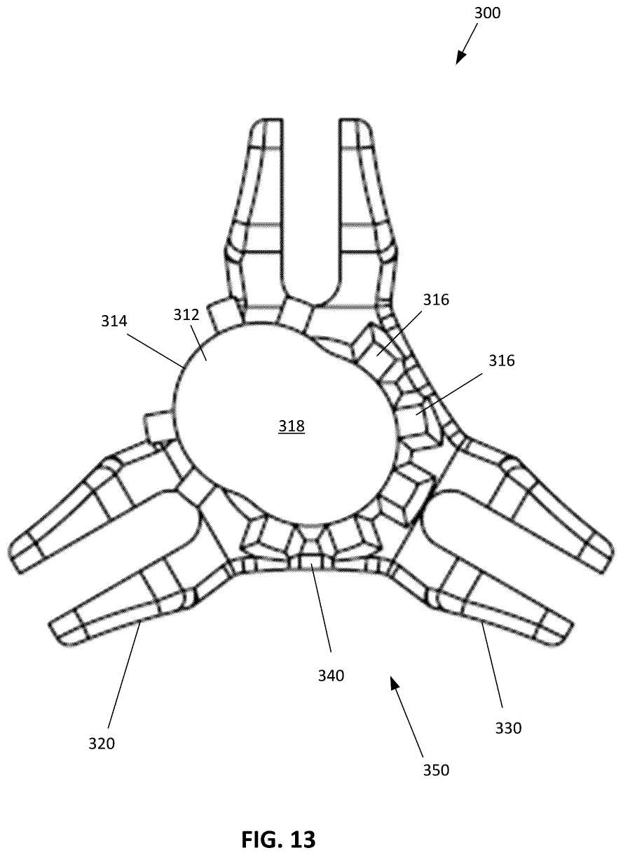

Turning to FIGS. 12 and 13, a bottom perspective view and a bottom view, respectively, of another embodiment of a battery positioning element according to the present invention are illustrated. The battery positioning element 300 has a lower end 302 (battery positioning element 300 is shown in an inverted position in FIGS. 12 and 13) and an upper end 304 opposite its lower end 302. The lower end 302 is configured to engage with the busbar plate 200 to couple the battery positioning element 300 with the busbar plate 200.

In this embodiment, the battery positioning element 300 includes a body or base plate 310 that has a coupling portion 312. The coupling portion 312 can be referred to alternatively as a splice column. As shown, the coupling portion 312 has an outer wall 314 from which splice edges 316 extend. The coupling portion 312 also has a lower end surface 318. In this embodiment, the overall shape defined by the outer wall 314 of the coupling portion 312 is an elongated oval-like shape.

Each battery positioning element 300 has three sets or pairs of contact parts or gripping portions that function to engage battery cells. In FIG. 12, only one set of contact parts are labeled and described in detail. It is to be understood that the same description applies to the other two sets of contact parts of the battery positioning element 300.

As shown, each set or pair of contact parts includes a first contact part 320 and a second contact part 330. Contact part 320 has an upper end 320A, a lower end 320B, and an outer end 320C. Contact part 320 has an angled or tapered surface 322 and another surface 324. Similarly, contact part 330 has an upper end 330A, a lower end 330B, and an outer end 330C. Contact part 330 has an angled or tapered surface 332 and another surface 334. Located between the first contact part 320 and the second contact part 330 is a central curved surface or contact part 340. Contact parts 320, 330, and 340 collectively define a receiving area 350 for a battery cell.

When a battery cell is inserted into the receiving area 350, the battery cell initially engages the angled surfaces 322 and 332 and contact part 340. As the battery cell is moved further into the receiving area 350, the battery cell moves along the angled surfaces 322 and 332 and then engages surfaces 324 and 334 of contact parts 320 and 330, respectively.

In the technical scheme, the pole lug of the battery pack busbar plate is respectively provided with a battery positioning element, and the battery can be directly inserted into the area enclosed by the corresponding battery positioning element to complete the positioning and facilitate welding. During the use of the battery pack, the batteries are still separated and fixed through the battery positioning element, so as to avoid adverse consequences such as short circuit caused by shaking. Improve the safety of use and extend the service life of the battery pack.

In the actual assembly process, you can also wrap all the batteries as a whole through the insulation packaging material, the two ends of the battery are exposed, and the gap corresponding to the battery positioning element is formed between the adjacent batteries, and then the battery positioning element installed on the busbar plate is inserted into the corresponding gap, the same can realize the mutual positioning between the adjacent batteries and the battery and the corresponding pole lug.

In summary, the battery positioning element is simple in structure, the battery positioning is fixed in the battery pack of the busbar plate, easy to weld, in addition, to avoid the battery pack during the use of the battery shake between the battery, improve the safety of use and extend the service life of the battery pack.

It should be noted that, in this context, the term “includes,” “contains” or any other variation thereof is intended to cover non-exclusive inclusion so that a process, method, article or device that includes a set of elements includes not only those elements but also other elements not expressly listed. Or elements inherent to such a process, method, article or equipment. Without any further limitation, the statement “includes a . . . ” does not preclude the existence of another identical element in the process, method, article or apparatus in which the element is included.

1. A battery positioning element that is securable to a busbar plate of a battery pack, the battery positioning element forming an area for battery positioning along an outer side of pole lugs of the busbar plate, the battery positioning element comprising:
a base plate and three gripping portions attached to the base plate, the base plate being securable to the busbar plate of the battery pack, the three gripping portions being disposed in equally spaced circumferential arrays, and each gripping portion is formed with gripping grooves corresponding to the batteries.

2. The battery positioning element of claim 1, wherein two sides of a clamping slot formed by contact parts of the battery positioning element form a convex extension of the contact parts, and the outer sides of the contact parts are an arc structure.

3. The battery positioning element of claim 2, wherein the battery positioning element is characterized in that a guide surface is arranged at one end of a contact part deviating from the busbar plate.

4. The battery positioning element of claim 1, wherein the battery positioning element has a bottom plate that is glued to the busbar plate.

5. The battery positioning element of claim 1, wherein a bottom of a bottom plate of the battery positioning element is protruded with a splice column, and the busbar plate is provided with a splicing hole corresponding to the splice column.

6. The battery positioning element of claim 5, wherein a surface of the splice column has a protrusion with a splice edge, and the splice edge matches the splice hole.

7. The battery positioning element of claim 5, wherein the splice column is arranged at one end away from the bottom plate, and a center of the splice column is arranged with an opening slot extending to the splice column.

8. The battery positioning element of claim 5, wherein the splice column is made of hot melt material, and an end of the splice column deviates from the bottom plate through the splice hole after hot sealing on a corresponding surface of the busbar.

9. The battery positioning element of claim 1, wherein every three to six battery positioning elements are used in combination to retain a battery cell.

10. The battery positioning element of claim 5, wherein the bottom plate of the battery positioning element has an elongate oval-like shape.

11. A battery pack comprising a battery positioning element as recited in claim 1.
